(19) United States
(12) Patent Application Publication
(10) Pub. No.: US 2014/0236981 A1
(43) Pub. Date: Aug. 21, 2014

(54) METHOD AND APPARATUS FOR IMPLEMENTING QUICK RETRIEVAL OF FILES

(71) Applicant: Tencent Technology (Shenzhen) Company Limited, Shenzhen (CN)

(72) Inventors: Zhigang ZHU, Shenzhen (CN); Hui CAO, Shenzhen (CN)

(73) Assignee: Tencent Technology (Shenzhen) Company Limited, Shenzhen (CN)

(21) Appl. No.: 14/265,259

(22) Filed: Apr. 29, 2014

Related U.S. Application Data
(63) Continuation of application No. PCT/CN2013/087695, filed on Nov. 22, 2013.

(30) Foreign Application Priority Data
Dec. 7, 2012 (CN) 201210521443.6

(51) Int. Cl. G06F 17/30

(52) U.S. Cl. CPC G06F 17/30386; G06F 17/30289; G06F 17/30604
USPC 707/758; 707/802

(57) ABSTRACT

A method performed at a device and a storage medium includes: reading files stored in the storage medium, including one or more first files stored at a first logical location and one or more second files stored at a second logical location in the storage medium, where the first logical location is reserved for a first application and the second logical location is reserved for a second application; generating a file database of the files; displaying a plurality of affordances, each respective affordance corresponding to one or more respective file display criteria; receiving an input corresponding to a command to select a first affordance of the plurality of affordances; and in response to receiving the input: determining from the file database files that satisfy, regardless of storage location in the storage medium, the respective file display criteria corresponding to the first affordance; and displaying information on the determined files.

### RELATED APPLICATIONS

This application is a continuation application of PCT Patent Application No. PCT/CN2013/087695, entitled “METHOD AND APPARATUS FOR IMPLEMENTING QUICK RETRIEVAL OF FILES” filed Nov. 22, 2013, which claims priority to Chinese Patent Application No. 201210521443.6, titled “Method and Apparatus for Implementing Quick Retrieval of Files,” filed Dec. 7, 2012, both of which are hereby incorporated by reference in their entirety.

### FIELD OF THE INVENTION

The present application relates to the field of computer technologies, and more particularly, to a method and a system for implementing quick retrieval of files.

### BACKGROUND

The Android operating system is a Linux-based open-source operating system, and is mainly used in portable devices, for example, mobile phones or tablet computers.

When using an Android device, a user usually needs to obtain content in a storage medium loaded on the Android device. Under normal circumstances, an Android system scans files on the storage medium and stores the files in a system database for users to make retrieval. However, not all types of files can be stored in the system database. For example, when a storage medium (such as an SD card) is loaded to a mobile phone, operating systems above Android3.0 may scan audio, pictures, video, installation packages and documents on the storage medium of the mobile phone and store them in a system database. Systems below Android3.0 only scan audio, pictures and video on the storage medium of the mobile phone and store them in the system database, but do not store installation packages and documents in the system database. Systems below Android3.0 only can obtain installation packages and documents through traversal, and the speed is much slower than directly reading a database. When the storage medium has lots of files, the processing speed becomes even slower. That is to say, if the user wants to retrieve the files that cannot be stored in the database of the Android system, the user needs to wait for a longer time.

### SUMMARY

In accordance with some embodiments, a method at a device with a display and a storage medium includes: reading a plurality of files stored in the storage medium, the plurality of files including one or more first files stored at a first logical location in the storage medium and one or more second files stored at a second logical location, distinct from the first location, in the storage medium, wherein the first logical location is reserved for a first application on the device and the second logical location is reserved for a second application on the device; generating a file database of the plurality of files, the file database including information on the plurality of files; displaying on the display a plurality of affordances, each respective affordance corresponding to one or more respective file display criteria; receiving an input corresponding to a command to select a first affordance of the plurality of affordances; and in response to receiving the input corresponding to the command to select the first affordance: determining from the file database one or more files of the plurality of files that satisfy, regardless of storage location in the storage medium, the respective file display criteria corresponding to the first affordance; and displaying on the display information on the determined files, including a list of the determined files.

In accordance with some embodiments, a device includes a display, a storage medium, one or more processors, and one or more programs, wherein the one or more programs are stored in the storage medium and configured to be executed by the one or more processors. The one or more programs including instructions for: reading a plurality of files stored in the storage medium, the plurality of files including one or more first files stored at a first logical location in the storage medium and one or more second files stored at a second logical location, distinct from the first location, in the storage medium, wherein the first logical location is reserved for a first application on the device and the second logical location is reserved for a second application on the device; generating a file database of the plurality of files, the file database including information on the plurality of files; displaying on the display a plurality of affordances, each respective affordance corresponding to one or more respective file display criteria; receiving an input corresponding to a command to select a first affordance of the plurality of affordances; and in response to receiving the input corresponding to the command to select the first affordance: determining from the file database one or more files of the plurality of files that satisfy, regardless of storage location in the storage medium, the respective file display criteria corresponding to the first affordance; and displaying on the display information on the determined files, including a list of the determined files.

In accordance with some embodiments, a non-transitory computer readable storage medium storing one or more programs, the one or more programs comprising instructions, which when executed by a device with a display and the storage medium, cause the device to: read a plurality of files stored in the storage medium, the plurality of files including one or more first files stored at a first logical location in the storage medium and one or more second files stored at a second logical location, distinct from the first location, in the storage medium, wherein the first logical location is reserved for a first application on the device and the second logical location is reserved for a second application on the device; generate a file database of the plurality of files, the file database including information on the plurality of files; display on the display a plurality of affordances, each respective affordance corresponding to one or more respective file display criteria; receive an input corresponding to a command to select a first affordance of the plurality of affordances; and in response to receiving the input corresponding to the command to select the first affordance: determine from the file database one or more files of the plurality of files that satisfy, regardless of storage location in the storage medium, the respective file display criteria corresponding to the first affordance; and display on the display information on the determined files, including a list of the determined files.

### BRIEF DESCRIPTION OF DRAWINGS

FIG. 1 is a schematic flow chart of a method for implementing quick retrieval of files in a first embodiment of the present application;

FIG. 2 is a schematic view of a specific flow of step S11 in FIG. 1;

FIG. 3 is a schematic view of traversing the storage medium in the first embodiment of the present application;

FIG. 4 is a schematic flow chart of a method for implementing quick retrieval of files in a second embodiment of the present application;

FIG. 5 shows a first schematic picture in a user education interface generated in step S22 in FIG. 4;

FIG. 6 shows a second schematic picture in a user education interface generated in step S22 in FIG. 4;

FIG. 7 shows a third schematic picture in a user education interface generated in step S22 in FIG. 4;

FIG. 8 is a schematic structural view of an apparatus for implementing quick retrieval of files in a third embodiment of the present application;

FIG. 9 is a schematic view of a specific structure of a storage module 31 in FIG. 8; and

FIG. 10 is a schematic structural view of an apparatus for implementing quick retrieval of files in a fourth embodiment of the present application.

FIG. 11 is a block diagram illustrating a device in accordance with some embodiments.

FIGS. 12A-12I illustrate user interfaces for a file manager application in accordance with some embodiments.

FIGS. 13A-13D illustrate a flow diagram of a method for implementing quick retrieval of files in accordance with some embodiments.

### DETAILED DESCRIPTION

To further illustrate the technical means adopted by the present application for achieving the predetermined invention objectives and efficacies, specific embodiments, methods, steps, features and efficacies of the method and apparatus for implementing quick retrieval of files according to the present application are described below in detail with reference to the accompanying drawings and preferred embodiments.

The above and other technical content, features and efficacies of the present application will be clearly presented in the following detailed descriptions of the preferred embodiments with reference to the accompanying drawings. The technical means adopted by the present application for achieving the predetermined invention objectives and efficacies can be understood more comprehensively and specifically with the descriptions about the specific embodiments, however, the accompanying drawings are only used to provide reference and illustration, but are not intended to limit the present application.

The present application mainly applies to terminal devices using an Android operating system. However, the solution put forward in the present application also applies to terminals using other operating systems in the case of similar problems. The terminal devices herein may be mobile phones, or products such as tablet computers, but the present application is not limited thereto.

### First Embodiment

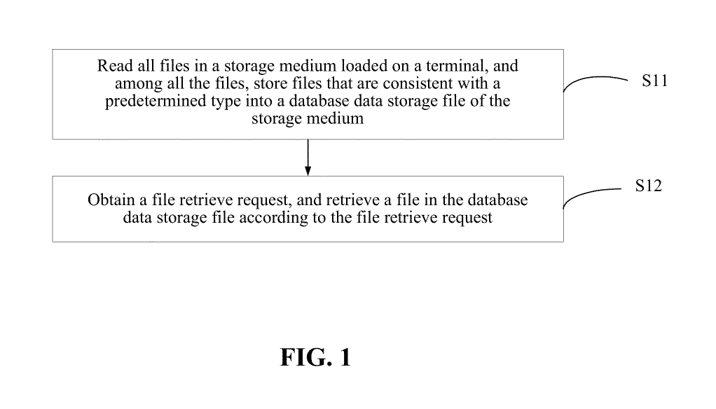

FIG. 1 is a schematic flow chart of a method for implementing quick retrieval of files in a first embodiment of the present application. Referring to FIG. 1, the method for implementing quick retrieval of files in the embodiment of the present application mainly includes the following steps:

S11: Read all files in a storage medium loaded on a terminal, and among all the files, store files that are consistent with a predetermined type into a database data storage file of the storage medium.

The files of the predetermined type may be a type of files that the android system cannot automatically store into the system database, such as installation packages or documents that systems below Android3.0 cannot automatically store into the system database. Certainly, the files of the predetermined type may also be other types of files, for example, files with an extension of .tmp, and the present application is not limited thereto.

The implementation method may be loaded into the terminal device as an application, and when the application is started for the first time, installation packages, documents and other files are obtained through traversing the storage medium, and such files are stored in the database data storage file of the storage medium. The database data storage file is used for managing such files having management demands, and is a file with .db as an extension; when the application is started for the first time, the file may be created, and the obtained installation packages, documents and other files are stored in the database data storage file. It is feasible that the database data storage file is directly read each time the application is started subsequently. The database data storage file is stored on a storage device. When the application generating the .db file is uninstalled, the .db file is also deleted along with the application.

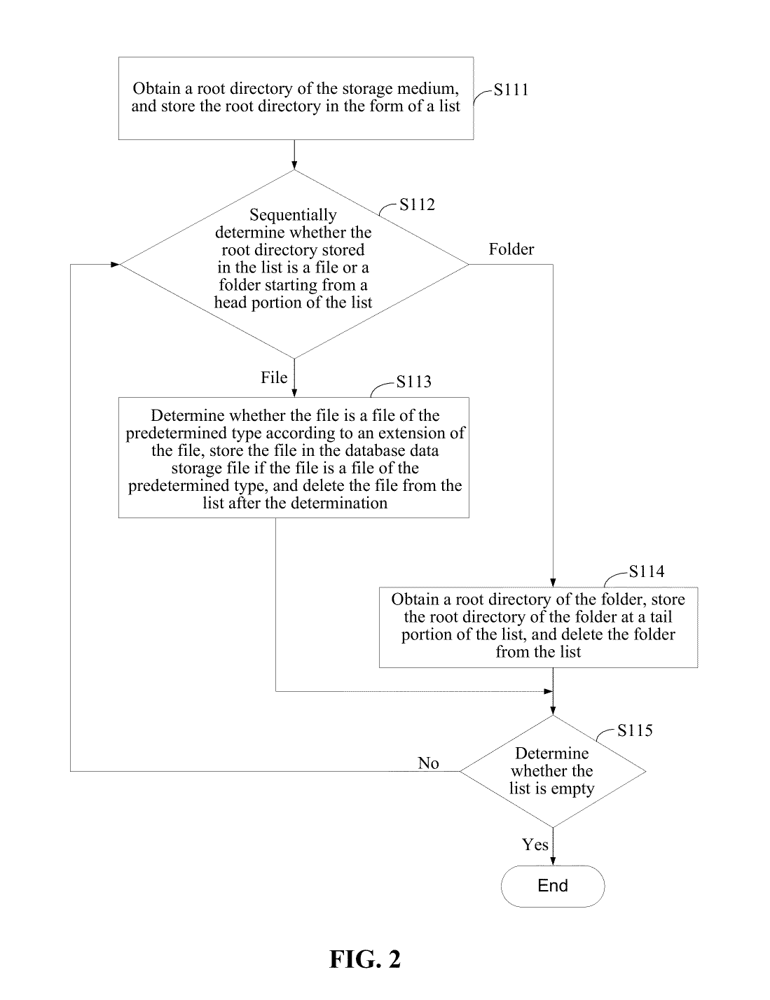

Preferably, in step S11, all the files in the storage medium are traversed and read through chain traversal, and the files consistent with the predetermined type are stored into the database data storage file. Specifically, referring to FIG. 2, step S11 may include the following steps.

S111: Obtain a root directory of the storage medium, and store the root directory in the form of a list.

S112: Sequentially determine whether the root directory stored in the list is a file or a folder starting from a head portion of the list, perform step S113 if it is a file, and perform step S114 if it is a folder.

S113: Determine whether the file is a file of the predetermined type according to an extension of the file, store the file in the database data storage file if the file is a file of the predetermined type, and delete the file from the list after the determination.

S114: Obtain a root directory of the folder, store the root directory of the folder at a tail portion of the list, and delete the folder from the list.

S115: Determine whether the list is empty, repeat step S112 to step S114 if the list is not empty; end the process if the list is empty.

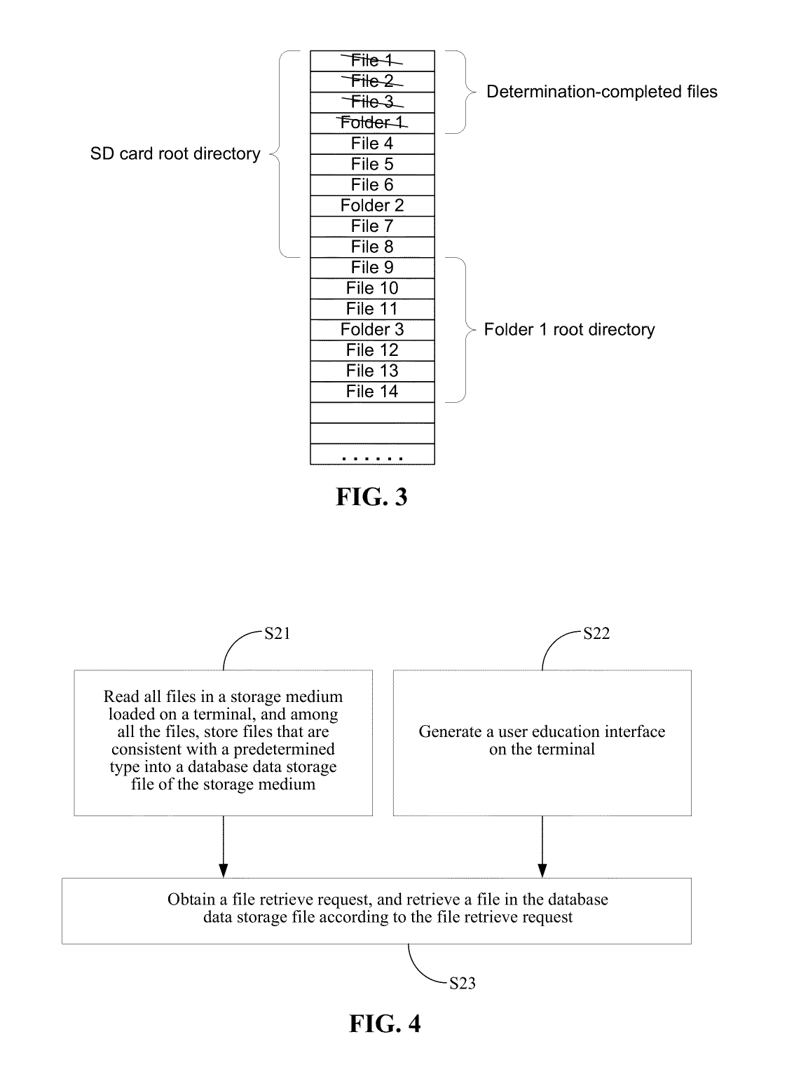

Referring to FIG. 3, it is assumed that the root directory of the storage medium includes file 1, file 2, file 3, folder 1, file 4, file 5, file 6, folder 2, file 7 and file 8. Starting from the head portion of the list, it is determined whether the file 1 is an installation package or document according to the extension of the file 1, and if the file 1 is an installation package or document, the file 1 is stored into the database data storage file; and the file 1 is deleted from the list after the determination. Then, determination is performed on the file 2 and the file 3 sequentially. When the traversal goes to the folder 1, the root directory (including file 9, file 10, file 11, folder 3, file 12, file 13, and file 14) of the folder 1 is obtained; the root directory of the folder 1 is stored at the tail portion of the list, and the folder 1 is deleted from the list. Operations in step S112 to step S114 are repeated until the list is empty.

S12: Obtain a file retrieve request, and retrieve a file in the database data storage file according to the file retrieve request. The file retrieve request herein may be understood as scanning all the files in the storage medium, or searching for files in the storage medium according to a user-set condition. For example, if the application is set as scanning all the files in the storage medium when obtaining a file retrieve request, the application can directly scan all the files in the system database and the database data storage file when the user starts the application and begins retrieving a file. In this case, the speed is fast, and the user does not need to wait. Further, the application also may classify the files according to the extensions of the files, for example, classifying the files into audio files, picture files and video files to be shown to users. If the application is set as searching for files in the storage medium according to a user-set condition, the user can set the type of files to be found when starting the application, for example, the user sets installation package-type files as files to be found, and then the application can directly find the files demanded by the user from the database data storage file without traversing the storage medium.

That is to say, when the application is started for the first time, files of the predetermined type, such as installation packages and documents are obtained through traversing the storage medium, and such files are stored into the database data storage file; when the application is started for the second time and in the future, files such as installation packages and documents can be directly obtained from the database data storage file without traversing the storage medium, and thus the speed is accelerated.

Further, when retrieving a file from the database data storage file, the storage medium may be traversed again in the background, to ensure that new files of the predetermined type added through other applications or storage medium (such as files downloaded through other applications, or files transferred when the terminal device is connected with a computer) are also retrieved and stored into the database data storage file.

Further, the method includes: monitoring content in the storage medium, and when a change operation is performed on a file corresponding to a file stored in the database data storage file, performing the same change operation on the file stored in the database data storage file.

In the method for implementing quick retrieval of files in this embodiment, all files in a storage medium loaded on a terminal are read, and among all the files, files that are consistent with a predetermined type are stored into a database data storage file of the storage medium; therefore, when needing to retrieve a file, the user can directly retrieve the file in the database data storage file, and the speed is increased a lot, which saves time for the user.

### Second Embodiment

FIG. 4 is a schematic flow chart of a method for implementing quick retrieval of files in a second embodiment of the present application. Referring to FIG. 4, the method for implementing quick retrieval of files in the embodiment of the present application mainly includes the following steps:

S21: Read all files in a storage medium loaded on a terminal, and among all the files, store files that are consistent with a predetermined type into a database data storage file of the storage medium. Please refer to step S11 in the first embodiment for this step, which is not repeated herein.

S22: Generate a user education interface on the terminal, where the user education interface teaches a user how to obtain files to be retrieved by means of pictures.

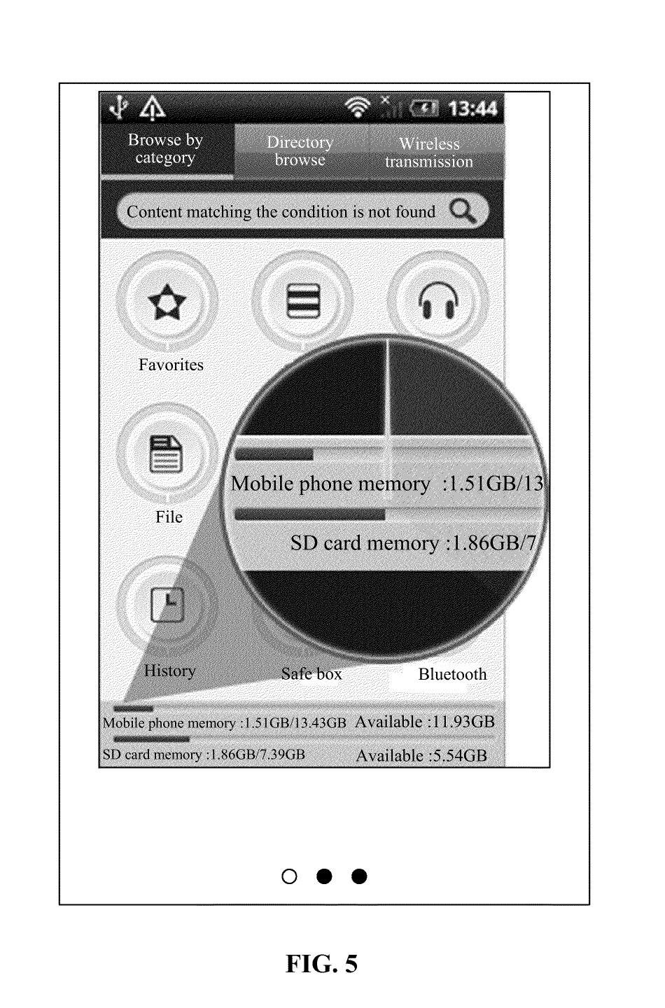

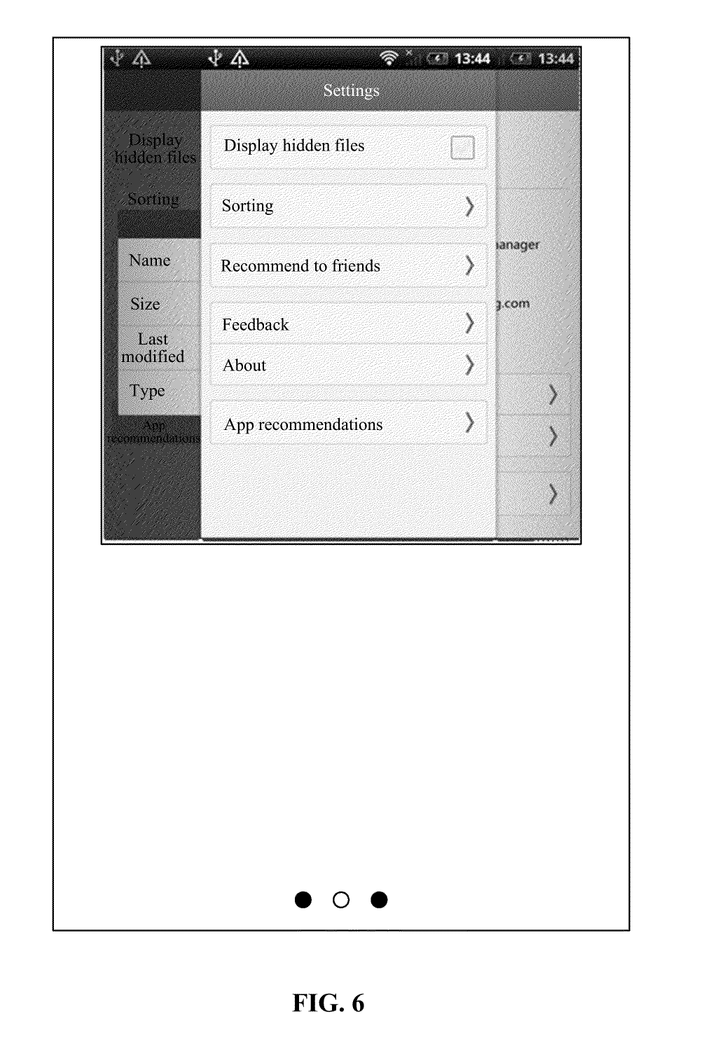

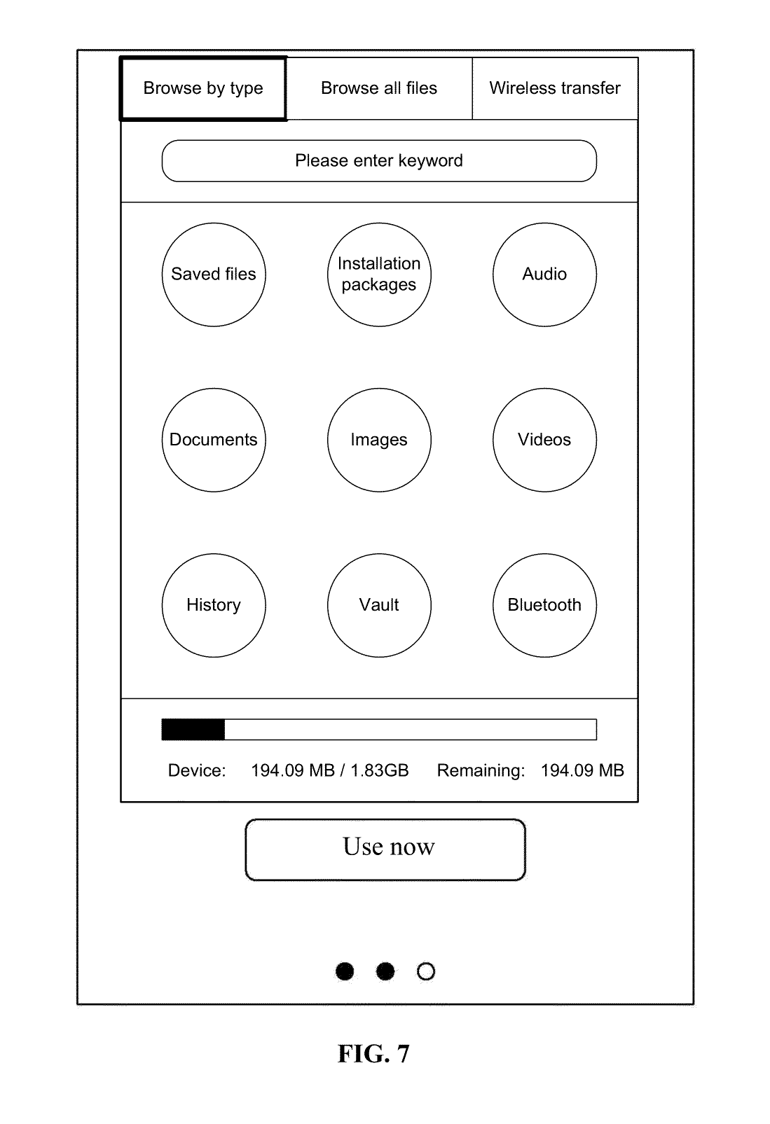

Step S22 may be performed simultaneously with step S21 or may be performed prior to step S21. Although an efficient traversing method may be used in step S21 to increase the reading speed, the efficiency is lower as compared with directly reading files from the database or the database data storage file. At this time, a user education interface may be generated so that the user watches the interface for a while, delaying the entrance to the main interface, and bringing about a time difference when the user uses the application for the first time, and with this time difference, the waiting time before the user enters the main interface for the first time is reduced or even disappears. The user education interface shows features of the application to the user by means of pictures, for example, how to use the application or which content is upgraded. Preferably, about 3 pages of user education pictures are displayed when the user starts the application for the first time; please refer to FIG. 5 to FIG. 7.

S23: Obtain a file retrieve request, and retrieve a file in the database data storage file according to the file retrieve request. Please refer to step S12 in the first embodiment for the step, which is not repeated herein.

In the method for implementing quick retrieval of files in this embodiment, all files in a storage medium loaded on a terminal are read, and among all the files, files that are consistent with a predetermined type are stored into a database data storage file of the storage medium; therefore, when needing to retrieve a file, the user can directly retrieve the file in the database data storage file, and the speed is increased a lot, which saves time for the user. Further, a user education interface is generated on the terminal, so that the user watches the interface for a while, delaying the entrance to the main interface.

### Third Embodiment

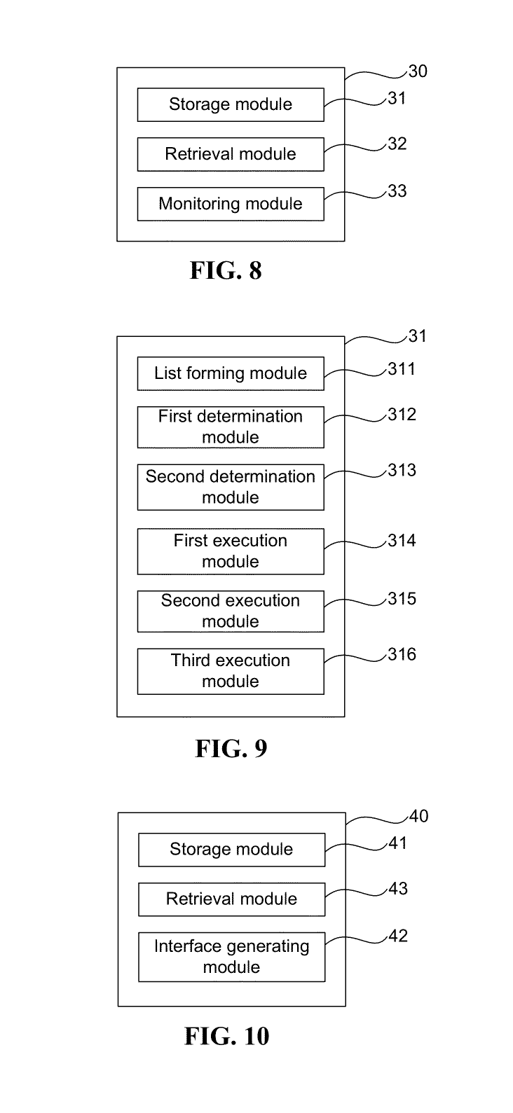

FIG. 8 is a schematic structural view of an apparatus for implementing quick retrieval of files in a third embodiment of the present application. Referring to FIG. 8, the apparatus 30 for implementing quick retrieval of files is used for implementing the method in the first embodiment, and mainly includes: a storage module 31 and a retrieval module 32.

The storage module 31 is used for reading all files in a storage medium loaded on a terminal and among all the files, storing files that are consistent with a predetermined type into a database data storage file of the storage medium. The retrieval module 32 is used for obtaining a file retrieve request, and retrieving a file in the database data storage file according to the file retrieve request.

The storage module 31 reads all the files in the storage medium through chain traversal, and stores the files consistent with the predetermined type into the database data storage file.

Referring to FIG. 9, further, the storage module 31 includes: a list forming module 311, a first determination module 312, a second determination module 313, a first execution module 314, a second execution module 315, and a third determination module 316.

The list forming module 311 is used for obtaining a root directory of the storage medium, and storing the root directory in the form of a list. The first determination module 312 is used for sequentially determining whether the root directory stored in the list is a file or a folder starting from a head portion of the list; if it is a file, the second determination module 313 determines whether the file is a file of the predetermined type according to an extension of the file. If the file is a file of the predetermined type, the first execution module 314 stores the file in the database data storage file, and deletes the file from the list after the determination. If it is a folder, the second execution module 315 obtains the root directory of the folder, stores the root directory of the folder at a tail portion of the list, and deletes the folder from the list. The third determination module 316 is used for determining whether the list is empty, and if the list is not empty, the first determination module 312 repeats the operation of sequentially determining whether the root directory stored in the form of the list is a file or a folder starting from the head portion of the list, until the list is empty.

Further, the apparatus 30 also includes a monitoring module 33, used for monitoring content in the storage medium; when a change operation is performed on a file corresponding to a file stored in the database data storage file, the same change operation is performed on the file stored in the database data storage file.

### Fourth Embodiment

FIG. 10 is a schematic structural view of an apparatus for implementing quick retrieval of files in a fourth embodiment of the present application. Referring to FIG. 10, the apparatus 40 for implementing quick retrieval of files is used for implementing the method in the second embodiment, and mainly includes: a storage module 41, an interface generating module 42, and a retrieval module 43.

The storage module 41 is used for reading all files in a storage medium loaded on a terminal, and among all files, storing files that are consistent with a predetermined type into a database data storage file of the storage medium. The interface generating module 42 is used for generating a user education interface on the terminal. The retrieval module 43 is used for obtaining a file retrieve request, and retrieving a file in the database data storage file according to the file retrieve request.

In sum, in the method and the apparatus for implementing quick retrieval of files according to the present application, all files in a storage medium loaded on a terminal are read, and among all the files, files that are consistent with a predetermined type are stored into a database data storage file of the storage medium; therefore, when needing to retrieve the file, the user the user can directly retrieve the file in the database data storage file; the speed is increased a lot as compared with the prior art, which saves time for the user.

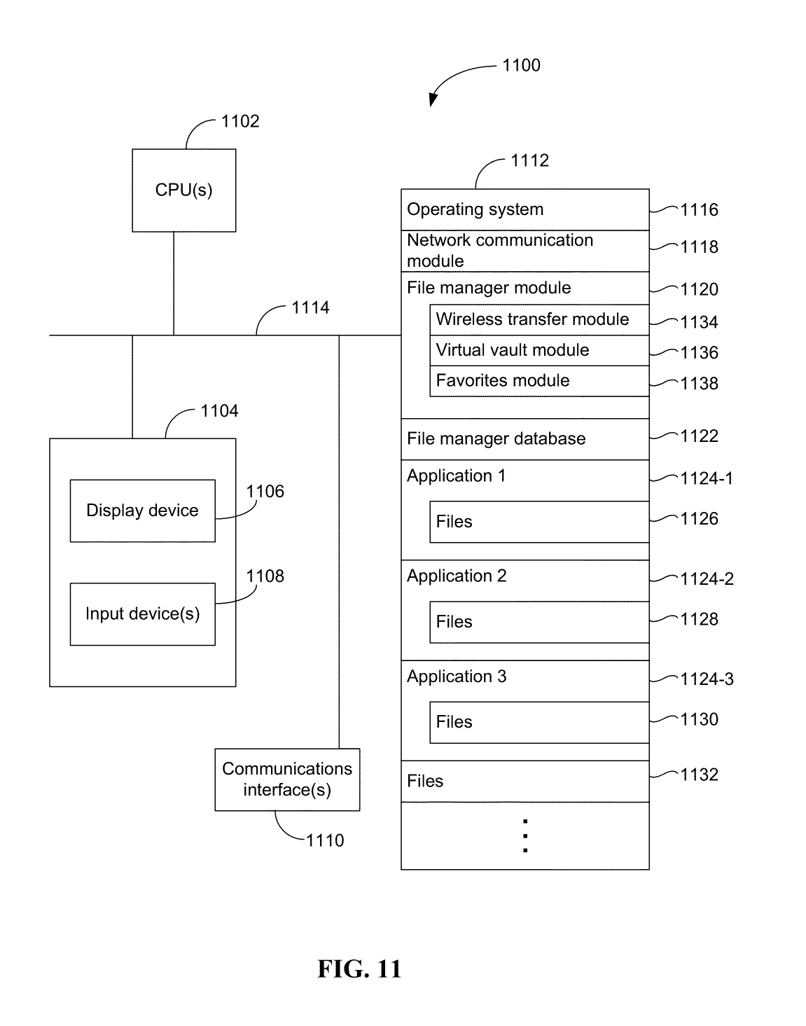

FIG. 11 is a block diagram illustrating a device 1100 in accordance with some embodiments. The device 1100 typically includes one or more processing units (CPU's) 1102 for executing modules, programs and/or instructions stored in memory 1112 and thereby performing processing operations; one or more network or other communications interfaces 1110; memory 1112; and one or more communication buses 1114 for interconnecting these components. The communication buses 1114 optionally include circuitry (sometimes called a chipset) that interconnects and controls communications between system components. The device 1100 includes a user interface 1104 comprising a display device 1106 and one or more input device(s) (e.g., keyboard, mouse, touch-sensitive surface) 1108. In some embodiments, an input device 1108 is integrated with the display device 1106. For example, a touch screen includes a touch-sensitive surface integrated with the display device 1106. Memory 1112 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 1112 may optionally include one or more storage devices remotely located from the CPU(s) 1102. Memory 1112, or alternately the non-volatile memory device(s) within memory 1112, comprises a non- transitory computer readable storage medium. In some embodiments, memory 1112, or the computer readable storage medium of memory 1112 stores the following programs, modules and data structures, or a subset thereof:
an operating system 1116 that includes procedures for handling various basic system services and for performing hardware dependent tasks;
a network communication module 1118 that is used for connecting the device 1100 to other computers via the one or more communication network interfaces 1110 (wired or wireless) and one or more communication networks, such as the Internet, other wide area networks, local area networks, metropolitan area networks, and so on;
a file manager module (or application) 1120 for generating and updating a file manager database 1122 of files 1126, 1128, 1130, and 1132 stored in memory 1112, as well as presenting a user interface for viewing files 1126, 1128, 1130, and 1132;
a file manager database 1122 (e.g., the database data storage file described above) for storing information about files 1126, 1128, 1130, and 1132;
one or more applications 1124; and
one or more files 1126, 1128, 1130, and/or 1132.

In some embodiments, the file manager module 1120 includes one or more of the modules described above in reference to FIGS. 8-10, for example storage module 31 (and modules 311-316) or 41, retrieval module 32 or 43, monitoring module 33, and/or interface generating module 42; the file manager 1120 is the application that reads the files in a storage medium (e.g., memory 1112) and stores files in the database data storage file (e.g., file manager database 1122) described above with reference to FIGS. 1-4.

In some embodiments, the file manager 1120 also includes a wireless transfer module 1134 for sending a file wirelessly to another device that also has the file manager module 1120, a virtual vault module 1136 for maintaining a virtual vault of files, and a favorites module 1138 for maintaining a favorites list or saved files list of files.

One or more applications 1124 are stored in memory 1112. Each application 1124 has space in memory 1112 logically reserved for that application. The reserved space for an application stores files (e.g., content files such as documents, audio files, video files, and images; application installation files or packages; files needed to run the application) associated with that application. For example, file(s) 1126 are associated with application 1124-1. File(s) 1128 are associated with application 1124-2. File(s) 1130 are associated with application 1124-3. Files 1132, which are not associated with any particular application 1124, are also stored in memory 1112. In some embodiments, an application cannot access space in memory 1112 that is not logically reserved for that application or that the application is not otherwise authorized to access. For example, application 1124-1 cannot access the space in memory 1112 for files 1128 to read or open a file 1128.

In some embodiments, memory 1112 includes space logically reserved for a virtual vault, and files added to a virtual vault is moved to that logical space. In some other embodiments, a file's status in or out of a virtual vault is indicated in the file manager database 1122, but the file, if it is added to a virtual vault, is not moved from one logical space to another. In some embodiments, more than one virtual vault can be created, and optionally each virtual vault has its own logically reserved space in memory 1112.

Each of the above identified elements may be stored in one or more of the previously mentioned memory devices, and corresponds to a set of instructions for performing a function described above. The above identified modules, units or programs (i.e., sets of instructions) need not be implemented as separate software programs, procedures, units or modules, and thus various subsets of these modules may be combined or otherwise re-arranged in various embodiments. In some embodiments, memory 1112 may store a subset of the modules and data structures identified above. Furthermore, memory 1112 may store additional modules and data structures not described above.

Although FIG. 11 shows a “device,” FIG. 11 is intended more as functional description of the various features which may be present in a set of servers than as a structural schematic of the embodiments described herein. In practice, and as recognized by those of ordinary skill in the art, items shown separately could be combined and some items could be separated.

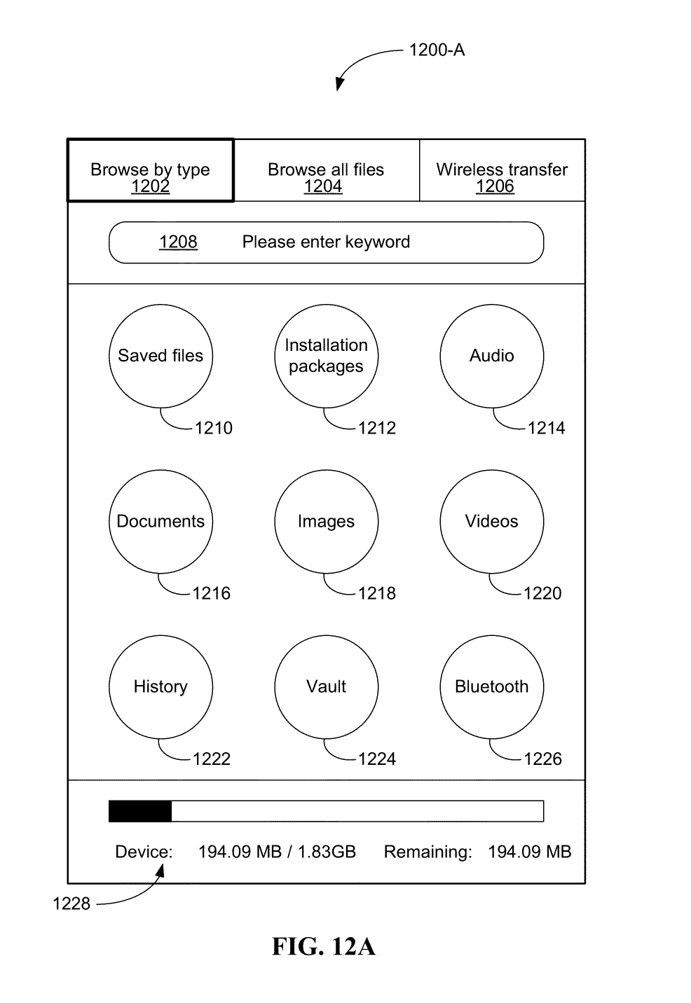

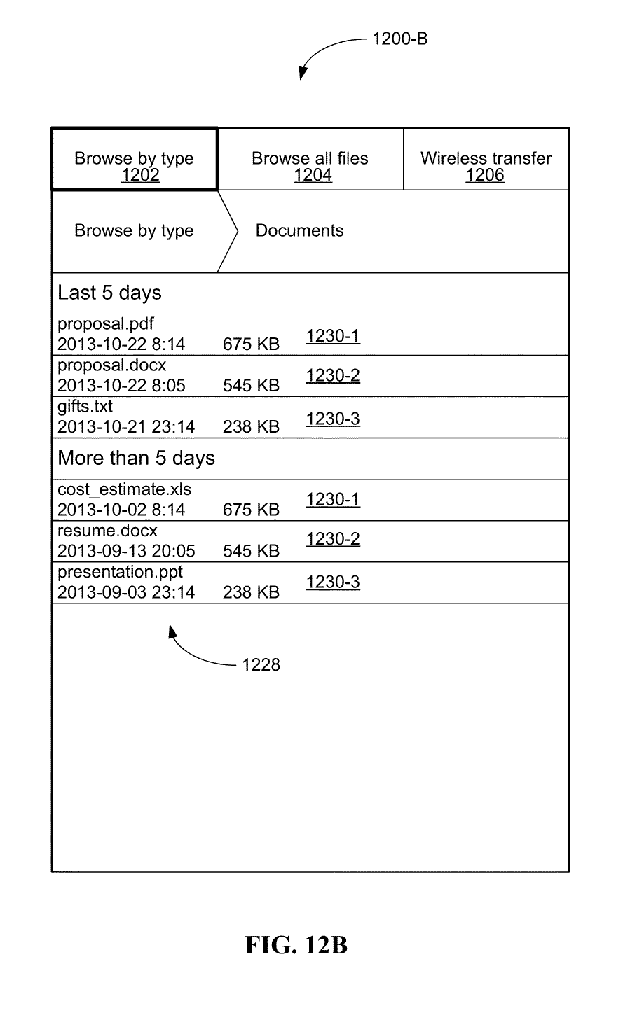

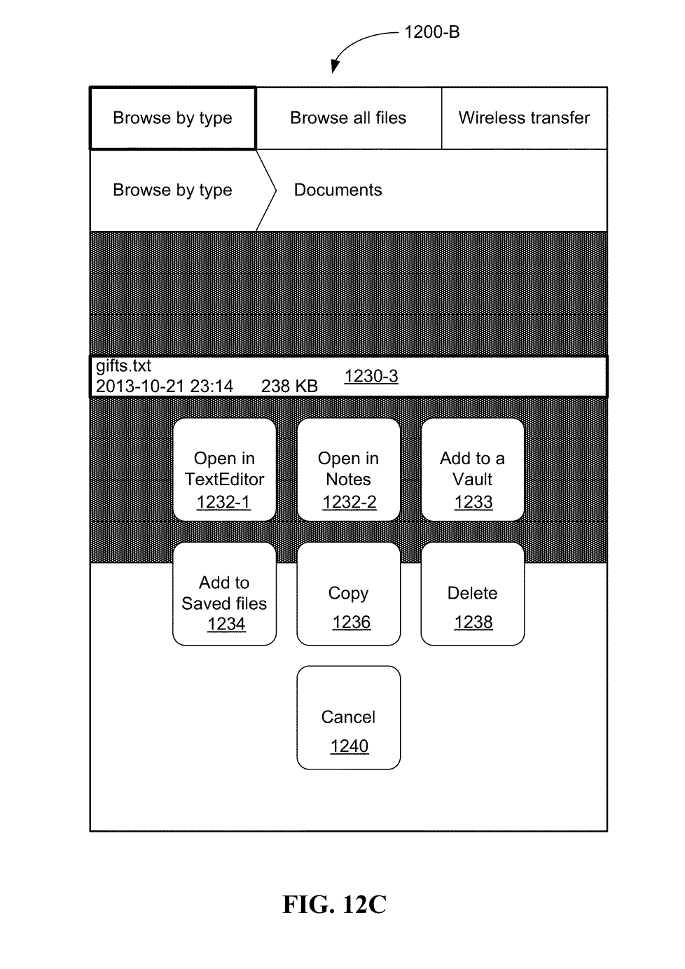

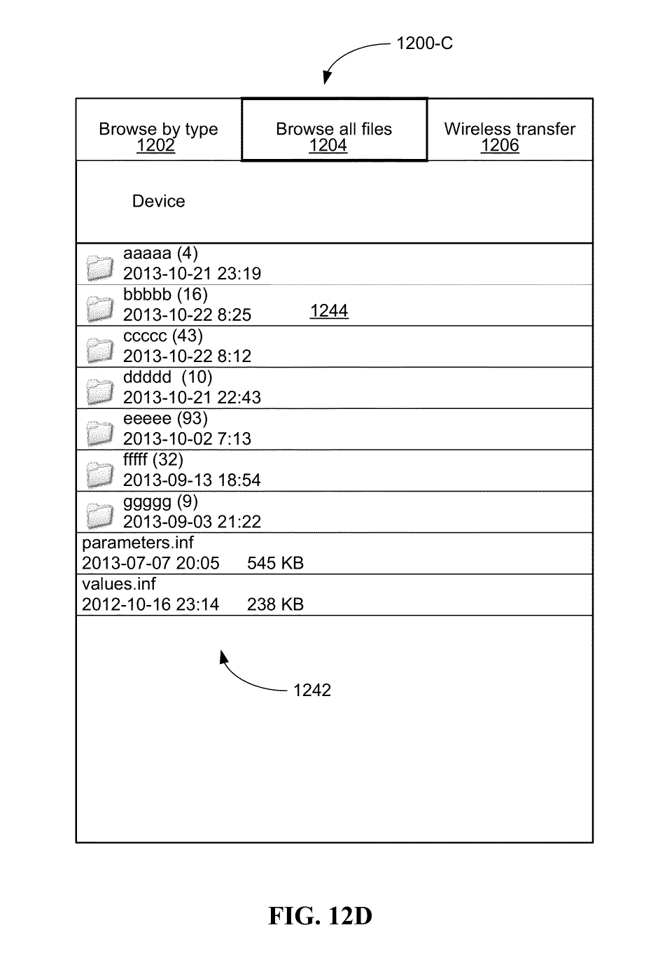

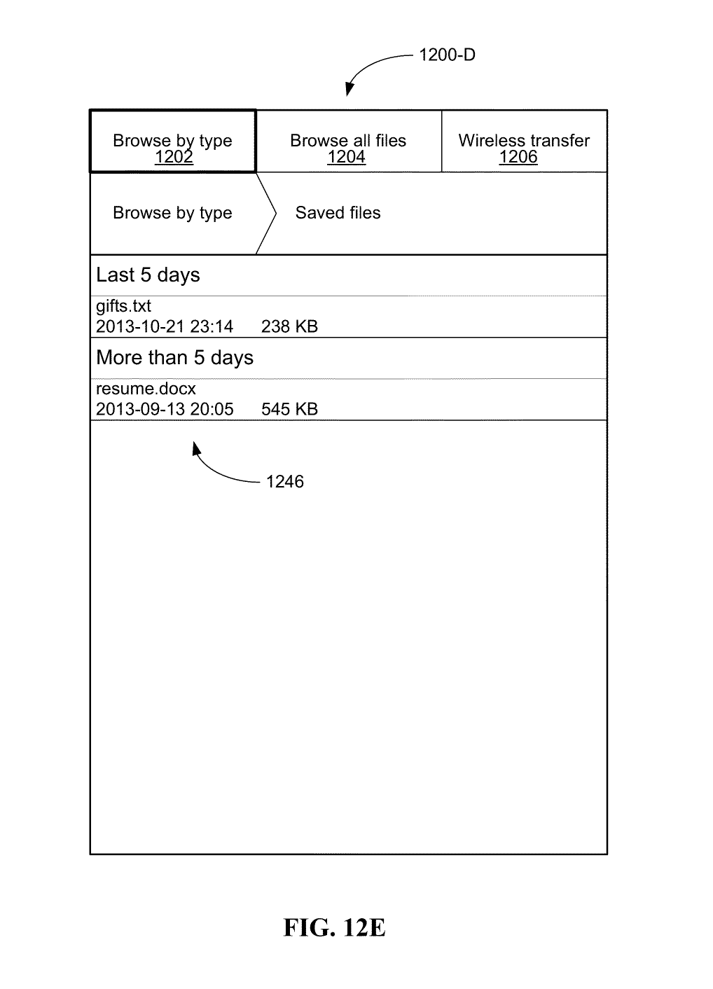

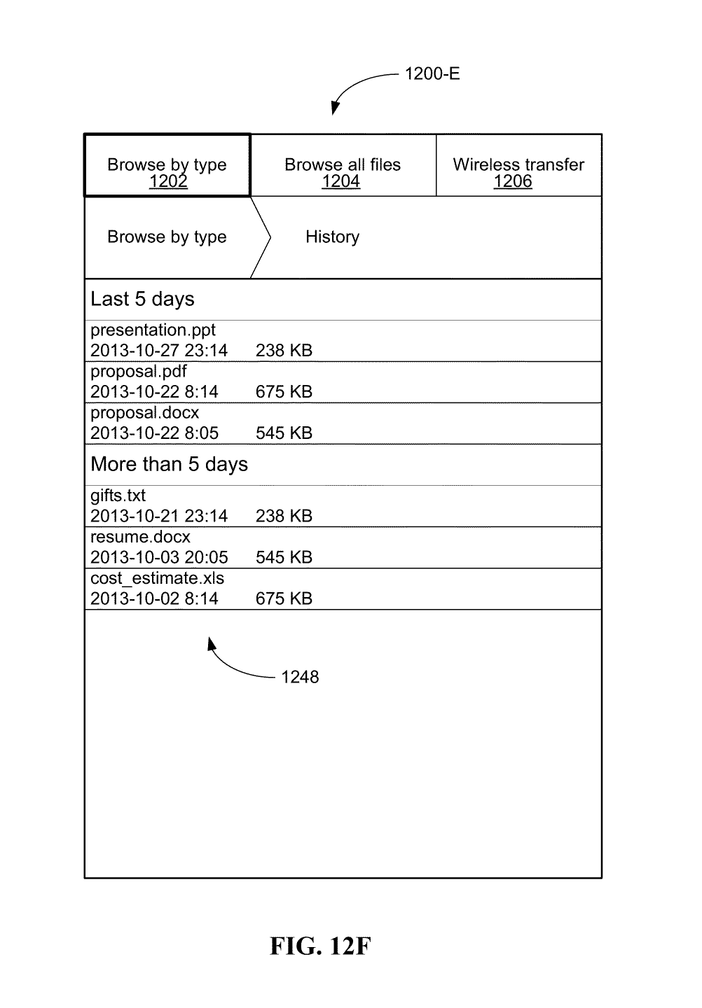

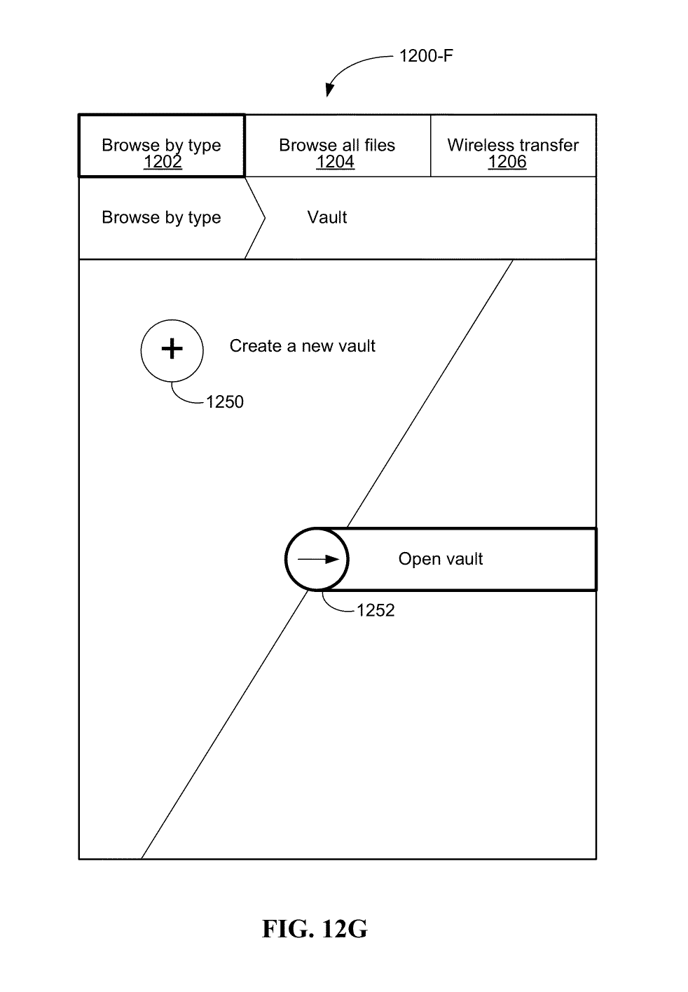

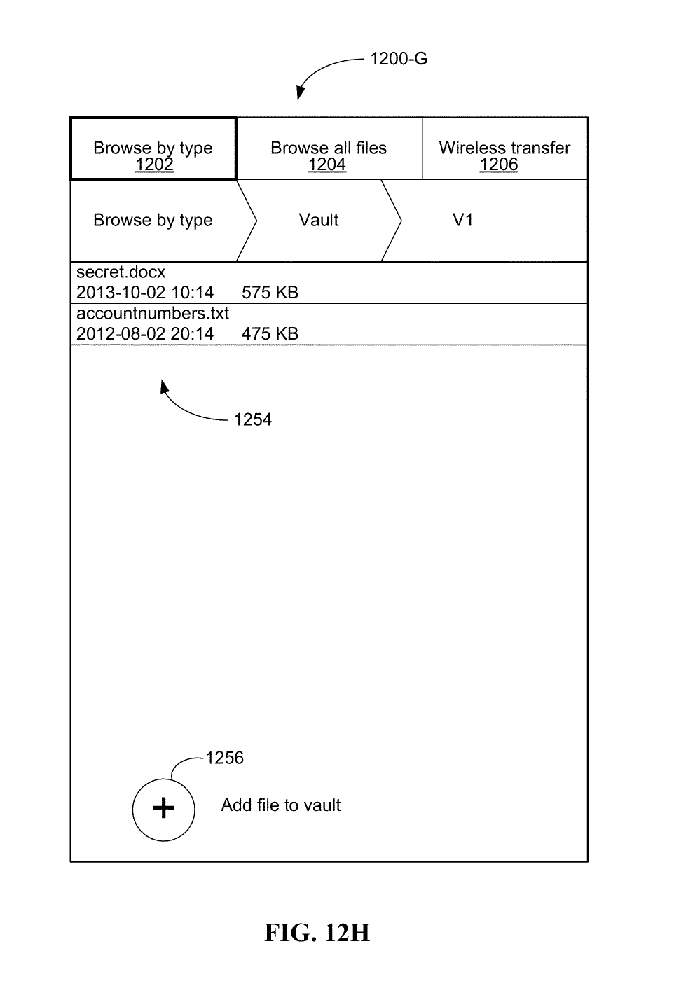

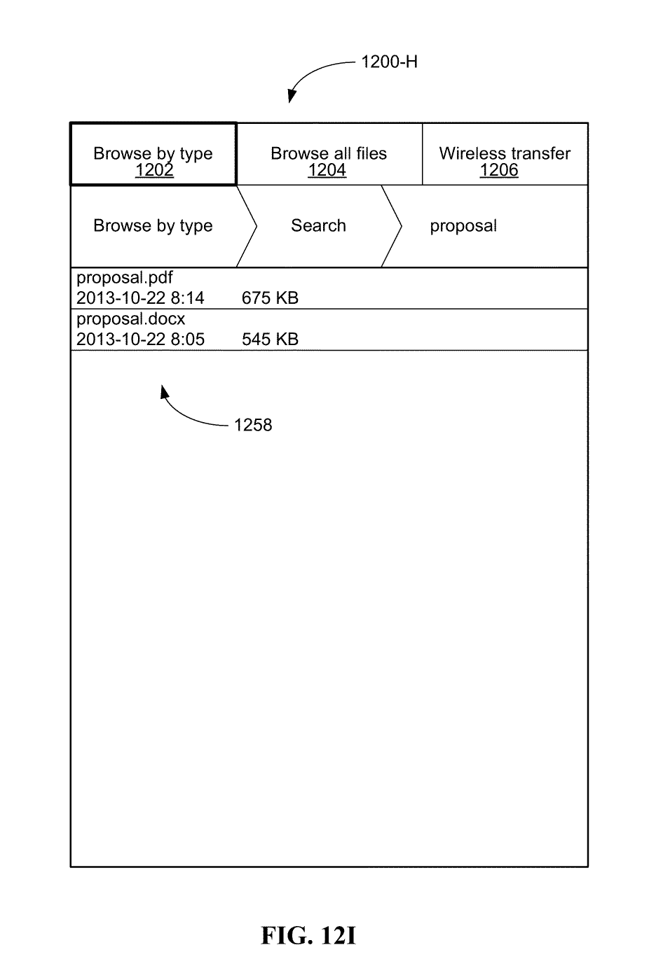

FIGS. 12A-12I illustrate user interface for a file manager application (e.g., file manager module 1120) in accordance with some embodiments. In some embodiments, the user interfaces illustrated in FIGS. 12A-12I are displayed on a touch screen of a device (e.g., a touch screen of device 1100).

User interface 1200-A includes a plurality of affordances (e.g., buttons and/or icons). The affordances include, for example, “browse by type” selector 1202, “browse all files” selector 1204, wireless transfer selector 1206, search box 1208, “saved files” icon 1210, “installation packages” icon 1212, “audio” icon 1214, “documents” icon 1216, “images” icon 1218, “video” icon 1220, “history” icon 1222, “vault” icon 1224, and “Bluetooth” icon 1226. In some embodiments, an affordance is activated by tapping on the affordance on the touch screen (e.g., with a tap gesture performed with a finger or a stylus). Each affordance corresponds to an input that corresponds to a command.

User interface 1200-A also includes storage space information 1228 indicating the amount of free space and used space on storage media (e.g., memory 1112, a removable memory card, device internal memory) active in the device. In some embodiments, storage space information 1228 displays the free space and used space on a per-storage medium basis.

In user interface 1200-A, browse-by-type selector 1202 is active, and affordances 1210-1226 and search box 1208 are displayed. Each of affordances 1210-1222 corresponds to a respective input that corresponds to a command to display one or more files in the file manager database 1122, or a list of the one or more files, that meet one or more file display criteria, regardless of the storage location of the file in the particular storage medium. For example, “documents” affordance 1216 corresponds to a command to display files that are documents; the file display criterion is whether a file is a document. In some embodiments, whether a file is a document or not is predefined based on the file extension; a file is considered to be a document if it has a file extension that matches one of a set of one or more file extensions that are predetermined to be file extensions for documents. When “documents” affordance 1216 is activated, user interface 1200-B is displayed, as shown in FIG. 12B. User interface 1200-B includes files list 1228 of files 1230 that match the criteria to which the activated affordance corresponds. In the case of FIG. 12B, file list 1228 includes files that are documents; files 1230-1 thru 1230-6 all have file extensions that are predetermined to be file extensions for documents. Any of the displayed files in file list 1228 can be selected (e.g., by performing a tap gesture on that file) for further action on that file. For example, if the file 1230-3 “gifts.txt” is selected, affordances 1232 thru 1238 are displayed, as shown in FIG. 12C. Affordances 1232-1 and 1232-2 are affordances for opening the file 1230-3 in a respective application, even if the file 1230-3 is not stored in a space reserved for the respective application; each of affordances 1232-1 and 1232-2 correspond to a respective application. Affordance 1240, when activated, cancels the display of affordances 1232 thru 1240.

Affordances 1212, 1214, 1218, and 1220 operate similarly to affordance 1216 as described above. When affordance 1212 is activated, the files list includes files that are application install files or packages. When affordance 1214 is activated, the files list includes files that are audio files (e.g., .mp3 files, .wav files). When affordance 1218 is activated, the files list includes files that are images (e.g., .jpg, .gif, .png). When affordance 1220 is activated, the files list includes files that are videos (e.g., .mpg, .mov, .avi, .mp4, .flv).

When affordance 1233 is activated, the virtual vault module 1136 initiates a process to add the file 1230-3 to a virtual vault, which is further described below with reference to FIGS. 12G-12H. When affordance 1233 is activated, the user is prompted to select a virtual vault to which the file will be added, and then prompted to enter a password for the selected vault. If the entered password is correct, the file is added to the selected vault.

When affordance 1234 is activated, the favorites module 1138 adds the file 1230-3 to a saved files list or a favorites list. When a file is added to the saved files list, the file is indicated as such in the file manager database 1122. The saved files list or favorites list include files that the user wants to have quick access to; the saved files list or favorites list saves the user the time expense of having to look through a full list of files, to browse through all the files in the storage medium, or to type a file search query.

Affordance 1236 is for copying the file 1230-3 to a location specified by the user, and affordance 1238 is for deleting the file 1230-3.

When “browse all files” selector 1204 is activated, user interface 1200-C is displayed, as shown in FIG. 12D. User interface 1200-C includes a hierarchical list 1242 of folders and files in the file manager database 1122; a file directory hierarchy is displayed. Thus, initially the hierarchal list 1242 includes the folders and files in a root directory or folder in the file manager database 1122. When a folder (e.g., folder 1244) is selected, the contents of that folder 1244 (sub-folders and files in folder 1244) are displayed in the list 1242. Thus, the user can browse through the file directory hierarchy and browse for files in the hierarchy. In some embodiments, the logically reserved space for a respective application is displayed as a folder, and the files stored in that space are displayed as files in the folder.

Referring back to user interface 1200-A, when affordance 1210 is activated, user interface 1200-D is displayed, as shown in FIG. 12E. User interface 1200-D includes a saved list (or favorites list) 1246 of files that a user added to the list 1246, regardless of the storage location of the file in the storage medium. The saved files list 1246 gives a user quick access to files the user frequently access without having to browse through directories or long lists of files matching particular criteria.

Referring back to user interface 1200-A, when affordance 1222 is activated, user interface 1200-E is displayed, as shown in FIG. 12F. User interface 1200-E includes a history 1248 of files in the file manager database 1122 that a user has previously accessed (e.g., opened, copied) on the device.

Referring back to user interface 1200-A, when affordance 1224 is activated, user interface 1200-F is displayed, as shown in FIG. 12G. User interface 1200-F includes an affordance 1250 to create a new virtual vault of files and affordance 1252 to open a virtual vault. A virtual vault maintains file privacy by allowing only an authorized person (e.g., the user with the correct password) to browse and access files added to the vault. A file that is in the virtual vault is not included in any of the lists 1228, 1242, 1246, or 1248 described above.

When affordance 1250 is activated (e.g., by a tap gesture), user interfaces for creating a vault (not shown) are displayed. The user interfaces for creating a vault take a user through a process of creating a vault, including naming the vault and creating a password for the vault.

When affordance 1252 is activated (e.g., by dragging affordance 1252 along a predetermined path), a list of one or more existing vaults are displayed. The user selects one of the vaults, and is prompted to enter the password for the selected vault. If the entered password is correct, files that are in the selected vault are displayed, e.g., as a files list 1254 in user interface 1200-G (FIG. 12H).

Also included in user interface 1200-G is affordance 1256 for adding a file to the currently opened vault. When affordance 1256 is activated, user interfaces for adding a file are displayed, including a user interface for selecting a method for browsing files (e.g., by type, by file directory hierarchy, history, saved list) and a list of files in accordance with the browsing method.

Referring back to user interface 1200-A, a search query or keyword can be entered into search box 1208. For example, when the query “proposal” is entered into search box 1208, a list 1258 of files that match the query is displayed, as shown in user interface 1200-H (FIG. 121)

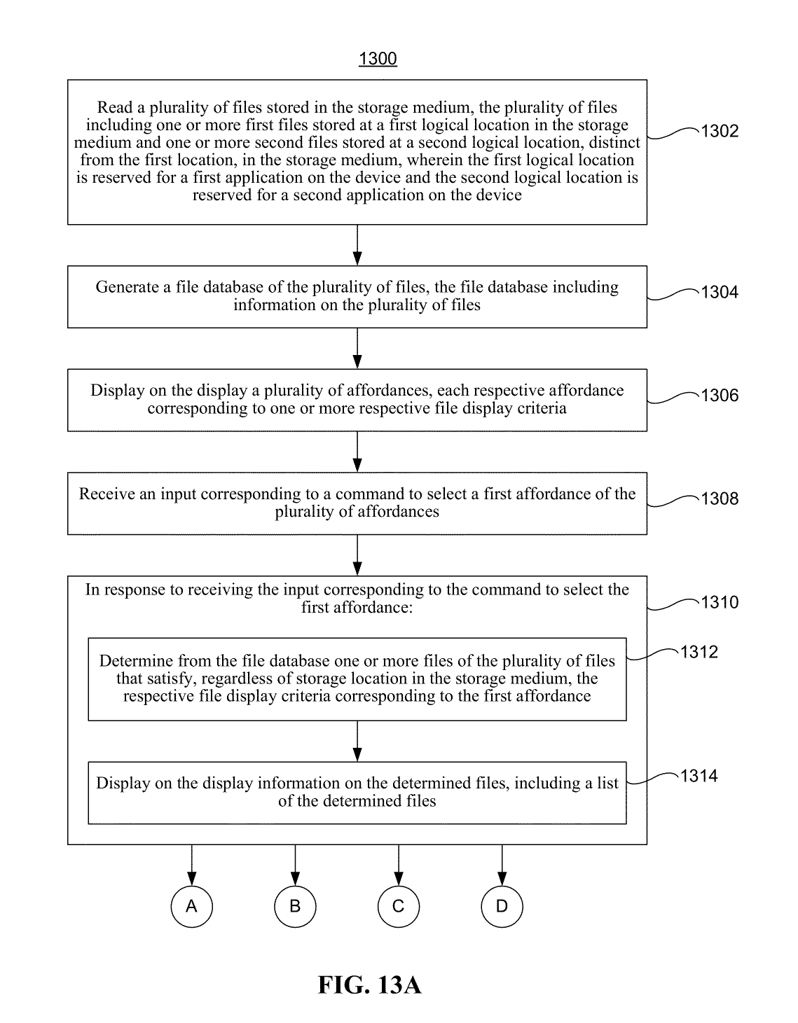

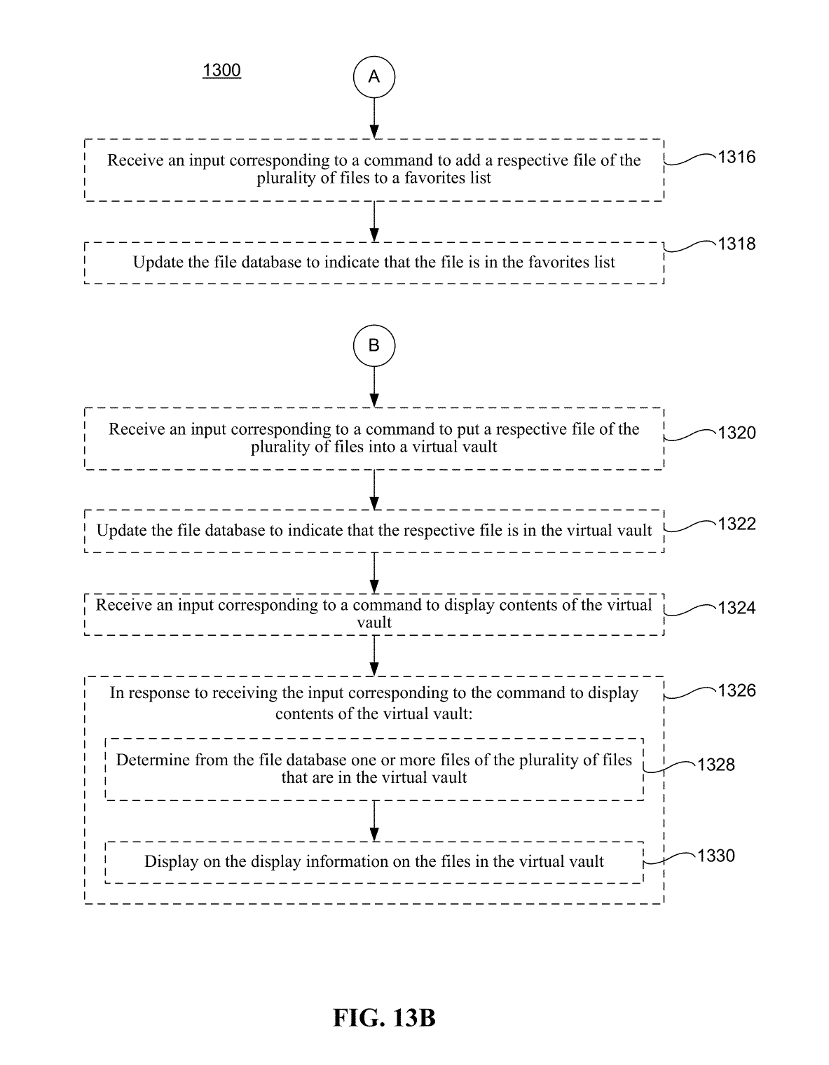

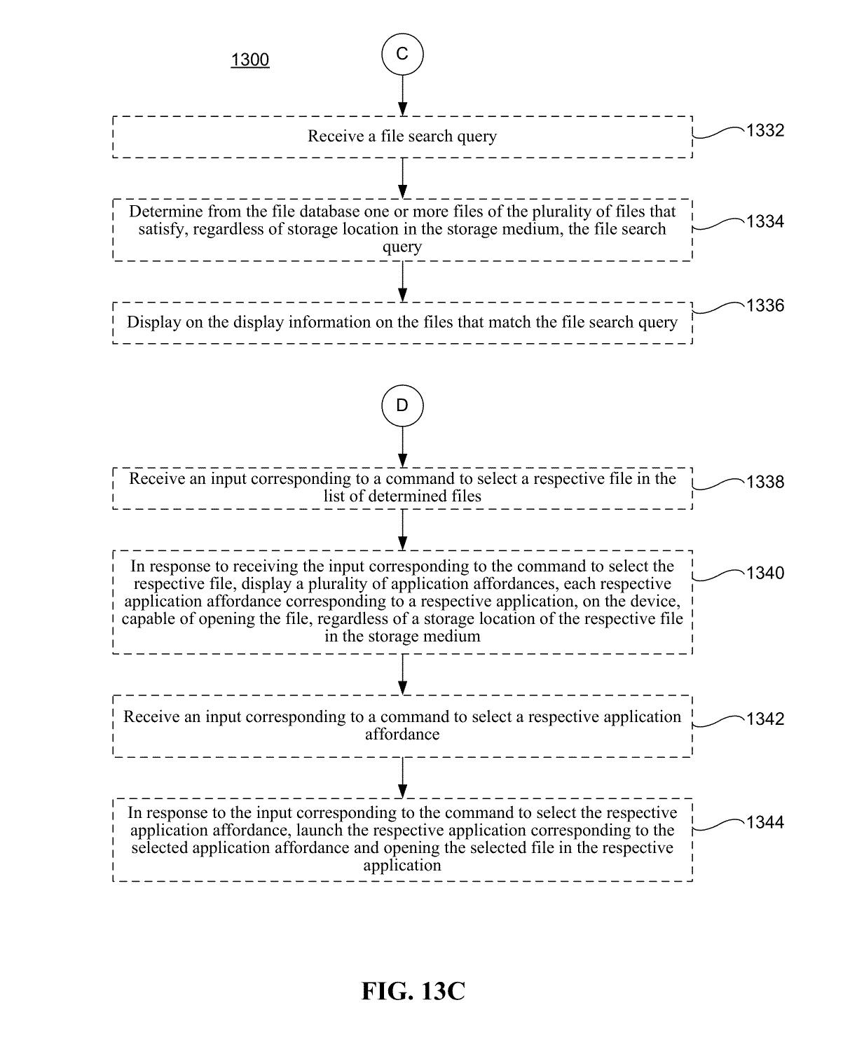

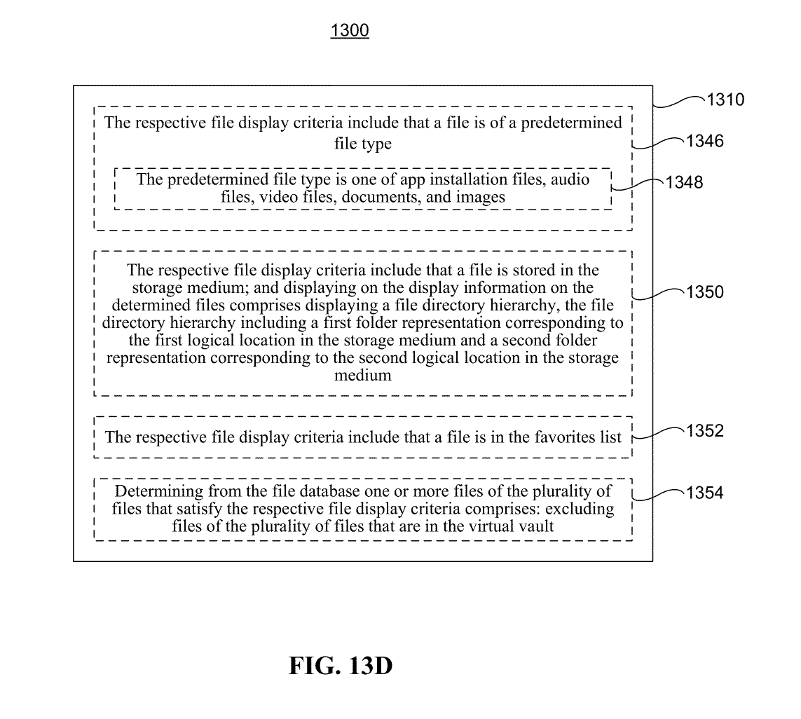

FIGS. 13A-13D illustrate a flow diagram of a method 1300 for implementing quick retrieval of files in accordance with some embodiments. In some embodiments, the method 1300 is performed on a device with a display and a storage medium.

The device reads (1302) a plurality of files stored in the storage medium. The plurality of files includes one or more first files stored at a first logical location in the storage medium and one or more second files stored at a second logical location, distinct from the first location, in the storage medium. The first logical location is reserved for a first application on the device and the second logical location is reserved for a second application on the device. In some embodiments, when the file manager module 1120 is first run on the device, the file manager module reads the files (e.g., 1126, 1128, 1130, 1132) stored in one or more active storage media (e.g., the device internal memory, a flash memory card) in the device. In some embodiments, memory 1112 collectively includes the one or more active storage media in the device. The files include one or more files stored at a logical location reserved for one application (e.g., files 1126 stored at a location reserved for application 1124-1) and one or more files stored at another logical location that is reserved for another application (e.g., files 1128 stored at a location reserved for application 1124-2). As more files are added to the device, the file manager module 1120 reads those files also.

The device generates (1304) a file database of the plurality of files. The file database includes information on the plurality of files. After reading the files, the file manager module 1120 generates a file database (e.g., file manager database 1122, the database data storage file described above with reference to FIGS. 1-10). The file manager database 1122 includes information on the plurality of files that is read by the file manager module 1120, such as size, last modified date, last access date, saved list status, vault status, whether the file is hidden, and so on. In some embodiments, the database 1122 includes information on all files in the storage medium. In some other embodiments, the database 1122 includes information on one or more predetermined file types (e.g., audio, video, images, documents, installation files).

In some embodiments, steps 1302 and 1304 correspond to step S11 in FIG. 1 above or step S21 in FIG. 4 above, as step S11 and S21 both include reading files in the storage medium and generating a database of files.

The device displays (1306) on the display a plurality of affordances. Each respective affordance corresponds to one or more respective file display criteria. The file manager module 1120 displays one or more affordances for displaying files in the file database in accordance with certain criteria. For example, user interface 1200-A (FIG. 12A) includes selectors 1202 and 1204, search box 1208, and icons 1210-1222. Selector 1204 corresponds to a criterion that the file be stored in the storage medium (and is in the file database), other than files that are in a virtual vault or otherwise hidden. Search box 1208 accepts a search query, and thus corresponds to a criterion that a file matches the search query. Icon 1210 corresponds to a criterion that a file is in a saved list or favorites list. Icon 1212 corresponds to a criterion that a file is an installation file or package. Icon 1214 corresponds to a criterion that a file is an audio file. Icon 1216 corresponds to a criterion that a file is a document file. Icon 1218 corresponds to a criterion that a file is an image file. Icon 1220 corresponds to a criterion that a file is a video file. Icon 1222 corresponds to a criterion that a file has been accessed by the user within the file manager module 1120 (e.g., within a predetermined time period, within the life of the file manager module 1120 on the device).

The device receives (1308) an input corresponding to a command to select a first affordance of the plurality of affordances. The input can be, depending on the particular affordance, a tap on a touch screen on which the affordance is display, entry and submission of a search query into a search box, or a dragging of the affordance along a predetermined path and/or to a predetermined location. For example, icon 1216 is selected by tapping on icon 1216 on the touch screen.

In response to receiving the input corresponding to the command to select the first affordance (1310), the device determines (1312) from the file database one or more files of the plurality of files that satisfy, regardless of storage location in the storage medium, the respective file display criteria corresponding to the first affordance; and displays (1314) on the display information on the determined files, including a list of the determined files. For example, in FIGS. 12A-12B, when icon 1216 is selected and activated, the file manager module 1120 determines one or more files in the file manager database 1122 that are documents and information on these files are displayed in list 1228. As another example, when icon 1214 is selected and activated, the file manager module 1120 determines one or more files in the file manager database 1122 that are audio files and information on these files are displayed in a list. The files in the list (e.g., list 1228) are displayed together regardless of storage location in the storage medium; files stored in spaces reserved for respective applications are displayed together.

In some embodiments, steps 1308-1314 correspond to steps S12 in FIG. 1 or step S23 in FIG. 4 above; selecting and activating an affordance that corresponds to respective file display criteria submits a file retrieve request (for files that meet the file display criteria) and one or more files that meet the criteria (i.e., satisfy the request) are retrieved from the file database and displayed.

In some embodiments, the respective file display criteria include that a file is of a predetermined file type (1346). In some embodiments, the predetermined file type is one of app installation files, audio files, video files, documents, and images (1348). For example, each of icons 1212, 1214, 1216, 1218, and 1220 correspond to a respective file type criterion; a file to be displayed is the predetermined file type. Icon 1212 corresponds to installation files or packages. Icon 1214 corresponds to audio files. Icon 1216 corresponds to documents. Icon 1218 corresponds to images. Icon 1220 corresponds to videos files.

In some embodiments, the respective file display criteria include that a file is stored in the storage medium, and displaying on the display information on the determined files includes displaying a file directory hierarchy (1350). The file directory hierarchy including a first folder representation corresponding to the first logical location in the storage medium and a second folder representation corresponding to the second logical location in the storage medium. For example, selector 1204 correspond a criterion that a file is stored in the storage medium (and is in the file database 1122). When selector 1204 is selected and activated, a hierarchal list 1242 of files and folders is displayed (FIG. 12D). The hierarchal list 1242 shows one node (e.g., root, a folder, a sub-folder) in a file directory hierarchy at a time. The user can browse and navigate the file directory hierarchy using the list 1242. The list 1242 includes files and folders. In some embodiments, space in the storage medium reserved for respective applications are represented as respective folders in the file directory hierarchy.

In other words, when the user wants to browse the file directory hierarchy, the file type is irrelevant, and the criterion for a file or folder to be displayed is simply that it is in the storage medium (and is not in a vault and not otherwise hidden (e.g., because it is a system file off-limits to users)).

In some embodiments, the device receives (1316) an input corresponding to a command to add a respective file of the plurality of files to a favorites list, and updates (1318) the file database to indicate that the file is in the favorites list. For example, when affordance 1234 is activated for a particular file (e.g., file 1230-3) (FIG. 12B), favorites module 1138 adds the file 1230-3 to the favorites list or saved files list, and file database 1122 is updated to indicate that file 1230-3 is in the favorites/saved files list.

In some embodiments, the respective file display criteria include that a file is in the favorites list (1352). When icon 1210 is selected and activated, the favorites module 1138 determines one or more files in the file manager database 1122 that are in the favorites/saved files list and information on these files are displayed in a list 1246 (FIG. 12E).

In some embodiments, the device receives (1320) an input corresponding to a command to put a respective file of the plurality of files into a virtual vault, and updates (1322) the file database to indicate that the respective file is in the virtual vault. For example, when affordance 1233 is activated for a file 1230, the virtual vault module 1136 guides the user through prompts to select a vault and enter a password. When those prompts are completed successfully, the virtual vault module 1136 adds the file 1230 to the selected vault. As another example, when affordance 1256 for a respective vault is selected and activated (FIG. 12H), the virtual vault module 1136 prompts the user to select a file to add the respective vault (e.g., affordances 1202-1222 are displayed and the user selects and activates any of these affordances to browse for and select the desired file) and to enter a password for the respective vault. When the prompts are completed, the virtual vault module 1136 adds the selected file to the respective vault.

In some embodiments, determining from the file database one or more files of the plurality of files that satisfy the respective file display criteria includes excluding files of the plurality of files that are in the virtual vault (1354). For example, when the file manager module 1120 determines the files that meet respective file display criteria (e.g., documents for icon 1216), the file manager module 1120 excludes files that are in any virtual vault; files that are in any virtual vault are not displayed in list 1228, 1242, 1246, 1248, or 1258.

In some embodiments, the device receives (1324) an input corresponding to a command to display contents of the virtual vault. In response to receiving the input corresponding to the command to display contents of the virtual vault (1326), the device determines (1328) from the file database one or more files of the plurality of files that are in the virtual vault, and displays (1330) on the display information on the files in the virtual vault. For example, when affordance 1252 is activated (FIG. 12G), the virtual vault module 1138 prompts the user to select a vault “to open” and to enter a password for the selected vault. When the prompts are completed, the virtual vault module 1138 determines, from the file manager database 1122, the files in the selected vault, and displays a list 1254 of the files in the selected vault (FIG. 12H).

In some embodiments, the device receives (1332) a file search query, determines (1334) from the file database one or more files of the plurality of files that satisfy, regardless of storage location in the storage medium, the file search query, and displays (1336) on the display information on the files that match the file search query. For example, when a file search query (e.g., a keyword) is entered into search box 1208 and submitted, the file manager module 1120 determines the files in file manager database 1122 that match the query. The files that match the query (other than files that are in a vault) are displayed in a list 1258 (FIG. 12I).

In some embodiments, the device receives (1338) an input corresponding to a command to select a respective file in the list of determined files. In response to receiving the input corresponding to the command to select the respective file, the device displays (1340) a plurality of application affordances, each respective application affordance corresponding to a respective application, on the device, capable of opening the file, regardless of a storage location of the respective file in the storage medium. For example, when file 1230-3 is selected from the list 1228 of document files, affordances 1232-1 and 1232-2 are displayed (FIG. 12C). Affordance 1232-1 corresponds to one application on the device that is capable of opening 1230-3, and affordance 1232-2 corresponds to another application on the device that is capable of opening 1230-3.

The device receives (1342) an input corresponding to a command to select a respective application affordance. In response to the input corresponding to the command to select the respective application affordance, the device launches (1344) the respective application corresponding to the selected application affordance and opening the selected file in the respective application. When affordance 1232-1 is selected and activated, the corresponding application (say, for example, application 1124-1) is launched and the file 1230-3 is opened in the launched application 1124-1. When affordance 1232-2 is selected and activated, a different corresponding application (say, for example, application 1124-2) is launched and the file 1230-3 is opened in the launched application 1124-2.

In some embodiments, the file 1230-3 is opened in the launched application even if the file 1230-3 is not stored in the reserved space for the launched application. For example, if the file 1230-3 is stored in the reserved space for files 1126, and the launched application is application 1124-2, the file 1230-3 is opened in application 1124-2 regardless.

It should be noted that, the embodiments in the specification are described in a progressive manner; the emphasis of the embodiments is different from each other; and for the same or similar parts between the embodiments, reference may be made to each other. As for the apparatus embodiments, the description is relatively simple as it is basically similar to the process embodiments; please refer to the description of the process embodiment for related content.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method, comprising:
at a device with a display and a storage medium:
reading a plurality of files stored in the storage medium, the plurality of files including one or more first files stored at a first logical location in the storage medium and one or more second files stored at a second logical location, distinct from the first location, in the storage medium, wherein the first logical location is reserved for a first application on the device and the second logical location is reserved for a second application on the device;
generating a file database of the plurality of files, the file database including information on the plurality of files;
displaying on the display a plurality of affordances, each respective affordance corresponding to one or more respective file display criteria;
receiving an input corresponding to a command to select a first affordance of the plurality of affordances; and
in response to receiving the input corresponding to the command to select the first affordance:
determining from the file database one or more files of the plurality of files that satisfy, regardless of storage location in the storage medium, the respective file display criteria corresponding to the first affordance; and
displaying on the display information on the determined files, including a list of the determined files.

2. The method of claim 1, wherein the respective file display criteria include that a file is of a predetermined file type.

3. The method of claim 2, wherein the predetermined file type is one of app installation files, audio files, video files, documents, and images.

4. The method of claim 1, wherein the respective file display criteria include that a file is stored in the storage medium; and displaying on the display information on the determined files comprises displaying a file directory hierarchy, the file directory hierarchy including a first folder representation corresponding to the first logical location in the storage medium and a second folder representation corresponding to the second logical location in the storage medium.

5. The method of claim 1, further comprising:
receiving an input corresponding to a command to add a respective file of the plurality of files to a favorites list; and
updating the file database to indicate that the file is in the favorites list.

6. The method of claim 5, wherein the respective file display criteria include that a file is in the favorites list.

7. The method of claim 1, further comprising:
receiving an input corresponding to a command to put a respective file of the plurality of files into a virtual vault; and
updating the file database to indicate that the respective file is in the virtual vault.

8. The method of claim 7, wherein determining from the file database one or more files of the plurality of files that satisfy the respective file display criteria comprises:
excluding files of the plurality of files that are in the virtual vault.

9. The method of claim 7, further comprising:
receiving an input corresponding to a command to display contents of the virtual vault; and
in response to receiving the input corresponding to the command to display contents of the virtual vault:
determining from the file database one or more files of the plurality of files that are in the virtual vault; and
displaying on the display information on the files in the virtual vault.

10. The method of claim 1, further comprising:
receiving a file search query;
determining from the file database one or more files of the plurality of files that satisfy, regardless of storage location in the storage medium, the file search query; and
displaying on the display information on the files that match the file search query.

11. The method of claim 1, further comprising:
receiving an input corresponding to a command to select a respective file in the list of determined files;
in response to receiving the input corresponding to the command to select the respective file, displaying a plurality of application affordances, each respective application affordance corresponding to a respective application, on the device, capable of opening the file, regardless of a storage location of the respective file in the storage medium;
receiving an input corresponding to a command to select a respective application affordance; and
in response to the input corresponding to the command to select the respective application affordance, launching the respective application corresponding to the selected application affordance and opening the selected file in the respective application.

12. A device, comprising:
a display;
a storage medium;
one or more processors; and
one or more programs, wherein the one or more programs are stored in the storage medium and configured to be executed by the one or more processors, the one or more programs including instructions for:
reading a plurality of files stored in the storage medium, the plurality of files including one or more first files stored at a first logical location in the storage medium and one or more second files stored at a second logical location, distinct from the first location, in the storage medium, wherein the first logical location is reserved for a first application on the device and the second logical location is reserved for a second application on the device;
generating a file database of the plurality of files, the file database including information on the plurality of files;
displaying on the display a plurality of affordances, each respective affordance corresponding to one or more respective file display criteria;
receiving an input corresponding to a command to select a first affordance of the plurality of affordances; and
in response to receiving the input corresponding to the command to select the first affordance:
determining from the file database one or more files of the plurality of files that satisfy, regardless of storage location in the storage medium, the respective file display criteria corresponding to the first affordance; and
displaying on the display information on the determined files, including a list of the determined files.

13. The device of claim 12, wherein the respective file display criteria include that a file is of a predetermined file type.

14. The device of claim 13, wherein the predetermined file type is one of app installation files, audio files, video files, documents, and images.

15. The device of claim 12, wherein the respective file display criteria include that a file is stored in the storage medium; and the instruction for displaying on the display information on the determined files further comprises instructions for displaying a file directory hierarchy, the file directory hierarchy including a first folder representation corresponding to the first logical location in the storage medium and a second folder representation corresponding to the second logical location in the storage medium.

16. The device of claim 12, wherein the one or more programs further include instructions for:
receiving an input corresponding to a command to add a respective file of the plurality of files to a favorites list; and
updating the file database to indicate that the file is in the favorites list.

17. The device of claim 12, wherein the one or more programs further include instructions for:
receiving an input corresponding to a command to put a respective file of the plurality of files into a virtual vault; and
updating the file database to indicate that the respective file is in the virtual vault.

18. The device of claim 12, wherein the one or more programs further include instructions for:
receiving a file search query;
determining from the file database one or more files of the plurality of files that satisfy, regardless of storage location in the storage medium, the file search query; and
displaying on the display information on the files that match the file search query.

19. The device of claim 12, wherein the one or more programs further include instructions for:
receiving an input corresponding to a command to select a respective file in the list of determined files;
in response to receiving the input corresponding to the command to select the respective file, displaying a plurality of application affordances, each respective application affordance corresponding to a respective application, on the device, capable of opening the file, regardless of a storage location of the respective file in the storage medium;
receiving an input corresponding to a command to select a respective application affordance; and
in response to the input corresponding to the command to select the respective application affordance, launching the respective application corresponding to the selected application affordance and opening the selected file in the respective application.

20. A non-transitory computer readable storage medium storing one or more programs, the one or more programs comprising instructions, which when executed by a device with a display and the storage medium, cause the device to:
read a plurality of files stored in the storage medium, the plurality of files including one or more first files stored at a first logical location in the storage medium and one or more second files stored at a second logical location, distinct from the first location, in the storage medium, wherein the first logical location is reserved for a first application on the device and the second logical location is reserved for a second application on the device;
generate a file database of the plurality of files, the file database including information on the plurality of files;
display on the display a plurality of affordances, each respective affordance corresponding to one or more respective file display criteria;
receive an input corresponding to a command to select a first affordance of the plurality of affordances; and
in response to receiving the input corresponding to the command to select the first affordance:
determine from the file database one or more files of the plurality of files that satisfy, regardless of storage location in the storage medium, the respective file display criteria corresponding to the first affordance; and
display on the display information on the determined files, including a list of the determined files.
